(19) United States
(12) Patent Application Publication
(10) Pub. No.: US 2014/0359433 A1
(43) Pub. Date: Dec. 4, 2014

(54) TEXT SELECTION PARAGRAPH SNAPPING

(71) Applicant: Microsoft Corporation, Redmond, WA (US)

(72) Inventors: Jan Louis Van Zyl, Bellevue, WA (US); Alexandre Douglas Pereira, Seattle, WA (US)

(21) Appl. No.: 13/909,073

(22) Filed: Jun. 4, 2013

(51) Int. Cl. G06F 17/24

(52) U.S. Cl. CPC G06F 17/24
USPC 715/256

(57) ABSTRACT

Aspects of the subject matter described herein relate to paragraph snapping. In aspects, a computing device receives user input regarding a selection of text. If the user input is expansion input, the computing device determines whether a set of one or more paragraph snapping conditions is satisfied. If the set of one or more paragraph snapping conditions is satisfied, the selection is snapped to the paragraph. If the user input is contraction input, the selection is shrunk and the paragraph snapping behavior is turned off for the paragraph until the selection activity is finished or until user input indicates that paragraph snapping behavior is to be re-enabled.

### BACKGROUND

With a touch sensitive screen or other input device, a user may attempt to select text to perform a text operation. Unfortunately, some types of input devices are not very accurate. For example, it may be difficult to select a precise starting point and ending point of desired text. This may lead to user frustration with devices that have other desirable features.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to paragraph snapping. In aspects, a computing device receives user input regarding a selection of text. If the user input is expansion input, the computing device determines whether a set of one or more paragraph snapping conditions is satisfied. If the set of one or more paragraph snapping conditions is satisfied, the selection is snapped to the paragraph. If the user input is contraction input, the selection is shrunk and the paragraph snapping behavior is turned off for the paragraph until the selection activity is finished or until user input indicates that paragraph snapping behavior is to be re-enabled.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” should be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary computing environment into which aspects of the subject matter described herein may be incorporated;

FIGS. 2-4 are block diagrams of exemplary user interfaces in accordance with aspects of the subject matter described herein; and

FIGS. 5-6 are flow diagrams that generally represent exemplary actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.”

As used herein, terms such as “a,” “an,” and “the” are inclusive of one or more of the indicated item or action. In particular, in the claims a reference to an item generally means at least one such item is present and a reference to an action means at least one instance of the action is performed.

Sometimes herein the terms “first”, “second”, “third” and so forth may be used. Without additional context, the use of these terms in the claims is not intended to imply an ordering but is rather used for identification purposes. For example, the phrases “first version” and “second version” do not necessarily mean that the first version is the very first version or was created before the second version or even that the first version is requested or operated on before the second version. Rather, these phrases are used to identify different versions.

Headings are for convenience only; information on a given topic may be found outside the section whose heading indicates that topic.

Other definitions, explicit and implicit, may be included below.

### Exemplary Operating Environment

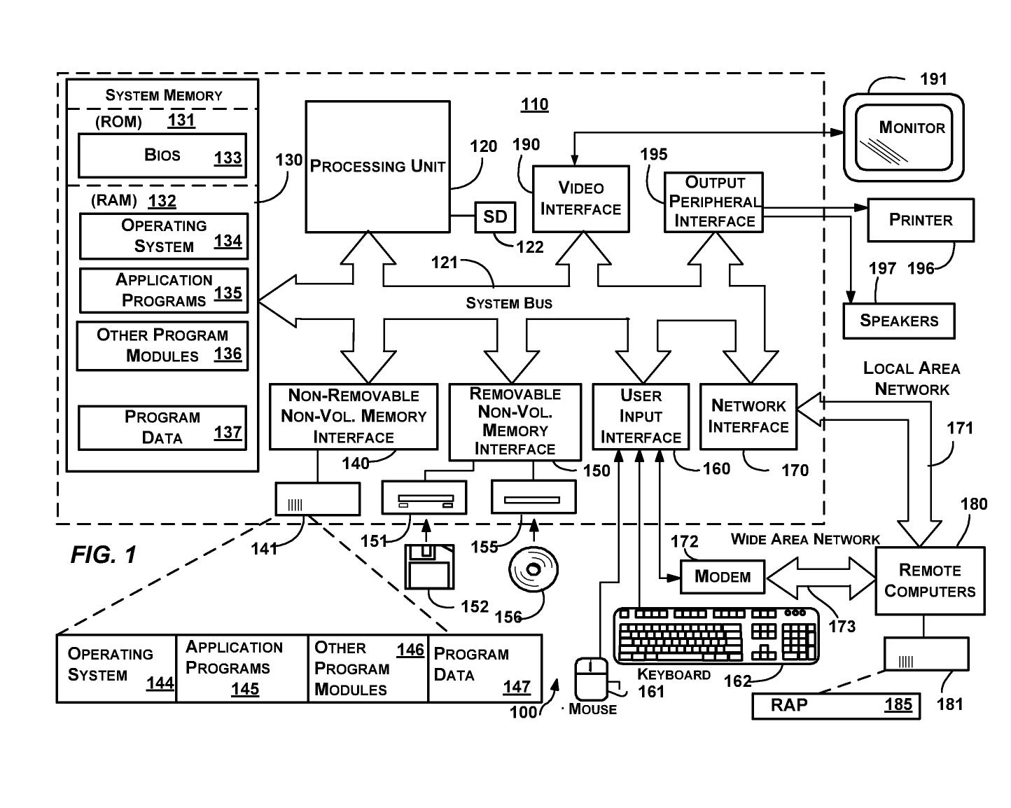

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well-known computing systems, environments, or configurations that may be suitable for use with aspects of the subject matter described herein comprise personal computers, server computers—whether on bare metal or as virtual machines—, hand-held or laptop devices, multiprocessor systems, microcontroller-based systems, set-top boxes, programmable and non-programmable consumer electronics, network PCs, minicomputers, mainframe computers, personal digital assistants (PDAs), gaming devices, printers, appliances including set-top, media center, or other appliances, automobile-embedded or attached computing devices, other mobile devices, phone devices including cell phones, wireless phones, and wired phones, distributed computing environments that include any of the above systems or devices, and the like. While various embodiments may be limited to one or more of the above devices, the term computer is intended to cover the devices above unless otherwise indicated.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Alternatively, or in addition, the functionality described herein may be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and the like.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and one or more system buses (represented by system bus 121) that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The processing unit 120 may be connected to a hardware security device 122. The security device 122 may store and be able to generate cryptographic keys that may be used to secure various aspects of the computer 110. In one embodiment, the security device 122 may comprise a Trusted Platform Module (TPM) chip, TPM Security Device, or the like.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, solid state storage, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110. Computer storage media does not include communication media.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM, DVD, or other optical media. Other removable/non-removable, volatile/nonvolatile computer storage media that can be used in the exemplary operating environment include magnetic tape cassettes, flash memory cards and other solid state storage devices, digital versatile discs, other optical discs, digital video tape, solid state RAM, solid state ROM, and the like. The hard disk drive 141 may be connected to the system bus 121 through the interface 140, and magnetic disk drive 151 and optical disc drive 155 may be connected to the system bus 121 by an interface for removable nonvolatile memory such as the interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone (e.g., for inputting voice or other audio), joystick, game pad, satellite dish, scanner, a touch-sensitive screen, a writing tablet, a camera (e.g., for inputting gestures or other visual input), or the like. These and other input devices are often connected to the processing unit 120 through a user input interface 160 that is coupled to the system bus, but may be connected by other interface and bus structures, such as a parallel port, game port or a universal serial bus (USB).

Through the use of one or more of the above-identified input devices a Natural User Interface (NUI) may be established. A NUI, may rely on speech recognition, touch and stylus recognition, gesture recognition both on screen and adjacent to the screen, air gestures, head and eye tracking, voice and speech, vision, touch, gestures, machine intelligence, and the like. Some exemplary NUI technology that may be employed to interact with a user include touch sensitive displays, voice and speech recognition, intention and goal understanding, motion gesture detection using depth cameras (such as stereoscopic camera systems, infrared camera systems, RGB camera systems, and combinations thereof), motion gesture detection using accelerometers/gyroscopes, facial recognition, 3D displays, head, eye, and gaze tracking, immersive augmented reality and virtual reality systems, as well as technologies for sensing brain activity using electric field sensing electrodes (EEG and related methods).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include phone networks, near field networks, and other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Paragraph Snapping

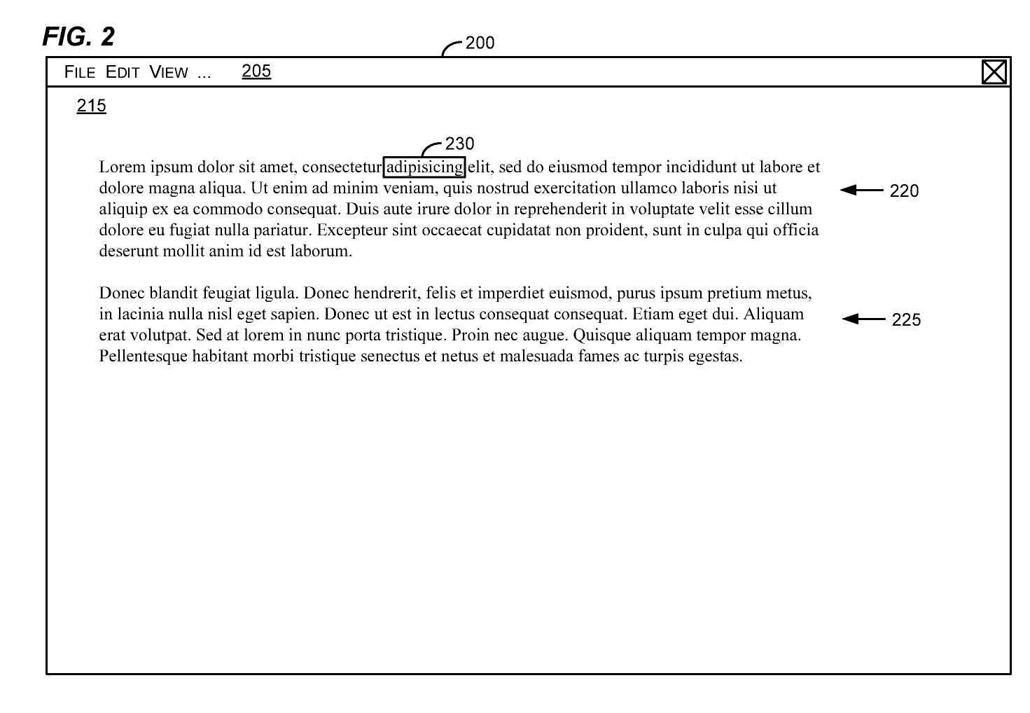

As mentioned previously, precise selection of text may be challenging with certain types of devices. FIGS. 2-4 are block diagrams of exemplary user interfaces in accordance with aspects of the subject matter described herein. Each user interface may include one or more elements. In general, an element (sometimes called a control) may be composed of zero or more other elements. For example, an element may include zero or more other elements which may include zero or more other elements and so forth. Furthermore, it will be recognized, that a user interface may have more, fewer, or other elements which may be arranged in a variety of ways without departing from the spirit or scope of the subject matter described herein.

Turning to FIG. 2, in one example, a window 200 may include a menu 205 and a pane 315 which are each elements of a user interface. The window 200 may also include other elements not shown.

As shown in FIG. 2, the menu 205 may include menu items such a file, edit, view, and other menu items as desired. Selecting a menu item may cause a submenu to appear which provides additional menu items to select from. Menu items in a submenu may cause additional submenus to appear and so forth.

The pane 215 may display one or more paragraphs of text. As illustrated, the pane 215 includes 2 paragraphs of text (e.g., paragraphs 220 and 225). A user may select text from the window 200 using traditional user input devices (e.g., mouse, keyboard, and the like) or any type of Natural User Interface (NUI), which has been described previously. For example, when the window 200 is displayed on a touch sensitive screen, the user may, in one embodiment, select a word by tapping a finger on the area corresponding to the selection 230.

Although a touch sensitive screen and user interaction regarding touching are sometimes mentioned herein, there is no intention to limit user input to these types of interactions. Where these types of interactions are described, it is to be understood that in other embodiments, other user input interactions may be substituted that are functionally equivalent to the user interactions described. Thus, user input that involves touching a touch sensitive screen and dragging a finger along the screen may be performed, in other embodiments, through the use of traditional input devices and/or through the use of a NUI.

After the user has selected a word (or indicated the starting point of a selection), the user may begin expanding the selection 230 by providing expansion input. For example, with a touch sensitive screen, the user may touch with a finger close to a handle (not shown) on the right side of the selection 230 and may begin dragging the finger to the right and/or down on the touch sensitive screen. As the user drags a finger, the selection 230 may expand to identify text that is now part of the selection 230.

As another example, with a touch sensitive screen, the user may touch with a finger close to a handle (not shown) on the left side of the selection 230 and may begin dragging the finger to the left and/or up on the touch sensitive screen. As the user drags a finger, the selection 230 may expand to identify text that is now part of the selection 230.

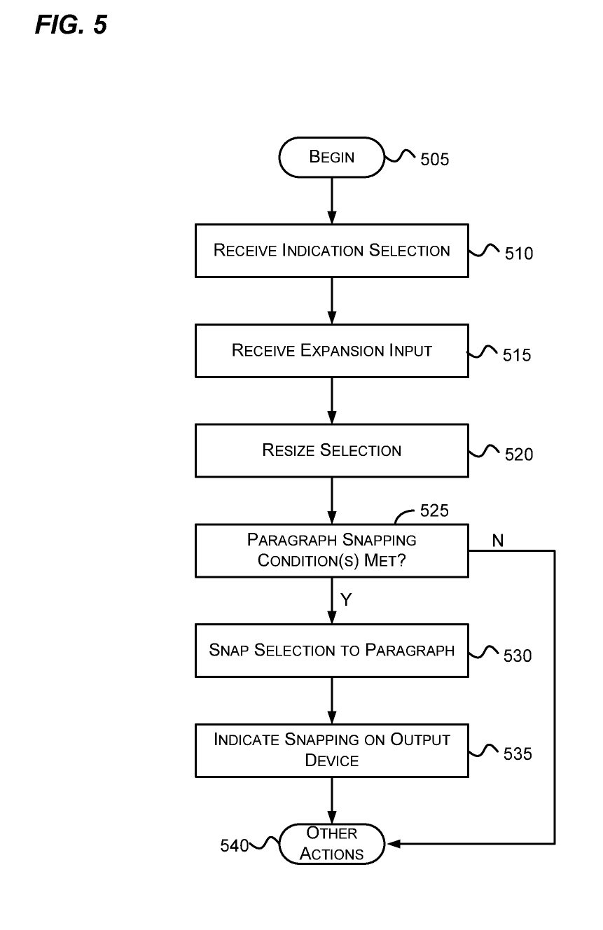

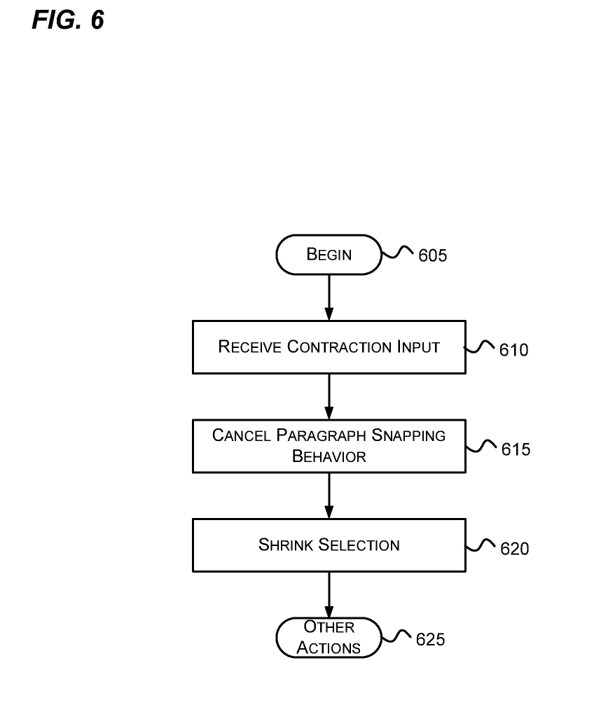

Paragraph snapping actions may occur as described below in conjunction with FIGS. 5-6. FIGS. 5-6 are flow diagrams that generally represent exemplary actions that may occur in accordance with aspects of the subject matter described herein. For simplicity of explanation, the methodology described in conjunction with FIGS. 5-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, two or more of the acts may occur in parallel or in another order. In other embodiments, one or more of the actions may occur with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 5, at block 505, the actions begin. At block 510, an indication of a selection is received. For example, referring to FIG. 2, a user may touch a touch sensitive device near the word in the area corresponding to the selection 230. In one example, touching the area may cause a word (e.g., the word within the selection 230) to be selected. In another example, touching the touch sensitive device in proximity to the area may cause a line, pointer, handle, inverted text, or some other indication that indicates a start or end of a selection.

At block 515, expansion input is received with respect to the selection. For example, referring to FIG. 2, a user may provide expansion input by dragging a finger to the right and/or down from the selection 230. In the English language, a person normally reads from left to right and from the top of a page to the bottom of the page. In other languages, a person may read from right to left and from the top of the page to the bottom of the page. This is sometimes referred to herein as reading in the direction of text flow and may include other combinations than mentioned above. Expansion input includes input in the direction of text flow and may depend on the language in which the text is written.

Expansion input may also include input in a direction opposite of text flow. For example, a user may provide expanding input by placing a finger on the start of the selection 230 and dragging the finger to the left and/or up from the selection 230.

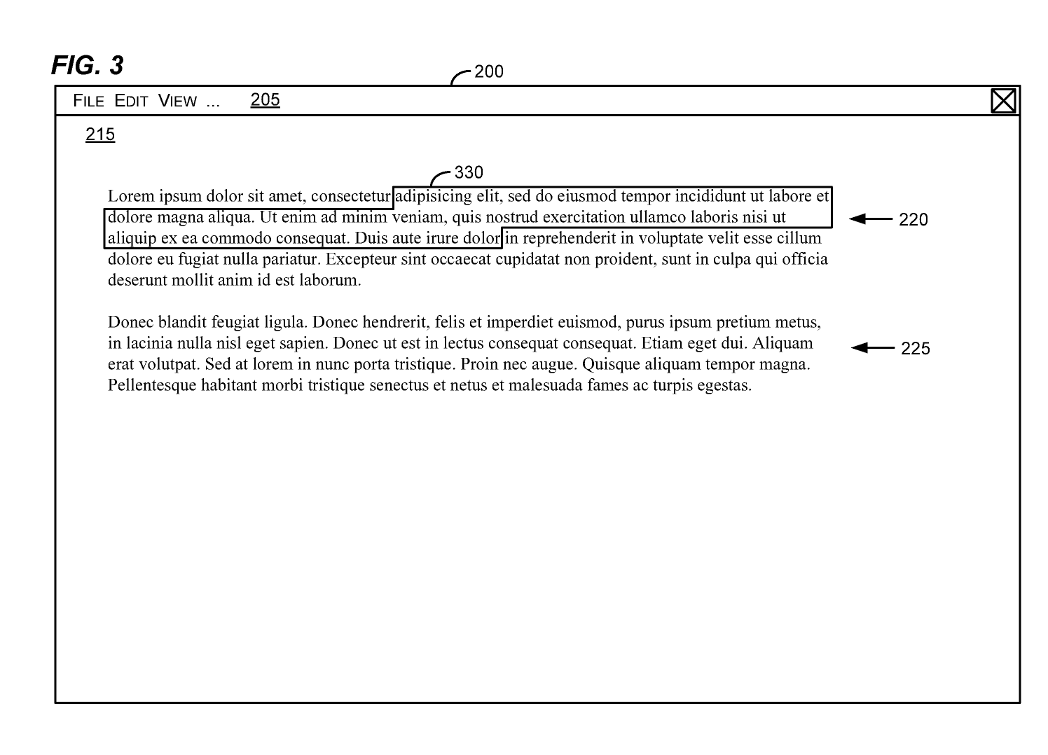

At block 520, the selection is resized in accordance with the expansion input. For example, referring to FIGS. 2 and 3, in response to a user dragging a finger downward, the selection 230 may be resized to the selection 330.

At block 525, if the selection as resized satisfies a set of one or more paragraph snapping conditions, the actions continue at block 530; otherwise, the actions continue at block 540. Below are indicated some exemplary paragraph snapping conditions. The examples below are not intended to be all-inclusive or exhaustive. Indeed, based on the teachings herein, those skilled in the art may recognize other examples that fall within the spirit and scope of aspects of the subject matter described herein. Exemplary paragraph snapping conditions include:

1. A selection includes at least N lines of text and the paragraph includes 2N lines of text. For example, if a selection includes 3 lines of text and a paragraph includes 6 lines of text, this snapping condition may be satisfied.

2. A selection includes at least X lines of text and the paragraph includes Y lines of text, where Y is greater than X, and X and Y are hard-coded or configurable. For example, if X=3 and Y=5 and if 3 lines of text of a paragraph 5 lines long are selected, this snapping condition may be satisfied.

3. A selection is greater than a pre-defined percentage of the paragraph. For example, in one implementation, the snapping percentage may be 50%. In another implementation, the snapping percentage may be 75%. In another implementation, the snapping percentage may be X where X is any percentage between 0 and 100.

The pre-defined percentage of the paragraph may be hard-coded or configurable. For example, user input may be received that may be used to define the pre-defined percentage. For example, in one implementation, a user may indicate one of three types of snapping behavior, namely: aggressive, non-aggressive, and no snapping.

For example, if the user indicates aggressive snapping behavior, the pre-defined percentage may be determined as 50% (or another percentage). If the user indicates non-aggressive snapping behavior, the pre-defined percentage may be determined as 75% (or another percentage). If the user indicates no snapping, paragraph snapping may be disabled.

As another example, a user may be able to enter an actual percentage. For example, a user interface may allow a user to enter a percentage that is to be used when paragraph snapping is enabled.

The snapping percentage may be based on lines, sentences, characters, words, area, or the like without departing from the spirit or scope of aspects of the subject matter described herein.

4. A previous paragraph has already been selected and the user expands the selection over a next paragraph. For example, referring to FIG. 2, if the paragraph 220 has already been selected (e.g., through paragraph snapping or via other selection) and the user expands the selection by dragging a finger over the first line of the paragraph 225, this may satisfy a condition for snapping the paragraph 225.

5. A selection starts at the beginning of a paragraph and includes an amount of text of the paragraph that is over a threshold. For example, referring to FIG. 2, if a selection starts at the beginning of the paragraph 225 and includes the first 2 lines of the paragraph 225, this snapping condition may be satisfied. The “amount of text” may include, for example, any of the measures previously indicated.

6. A combination of two or more of the above.

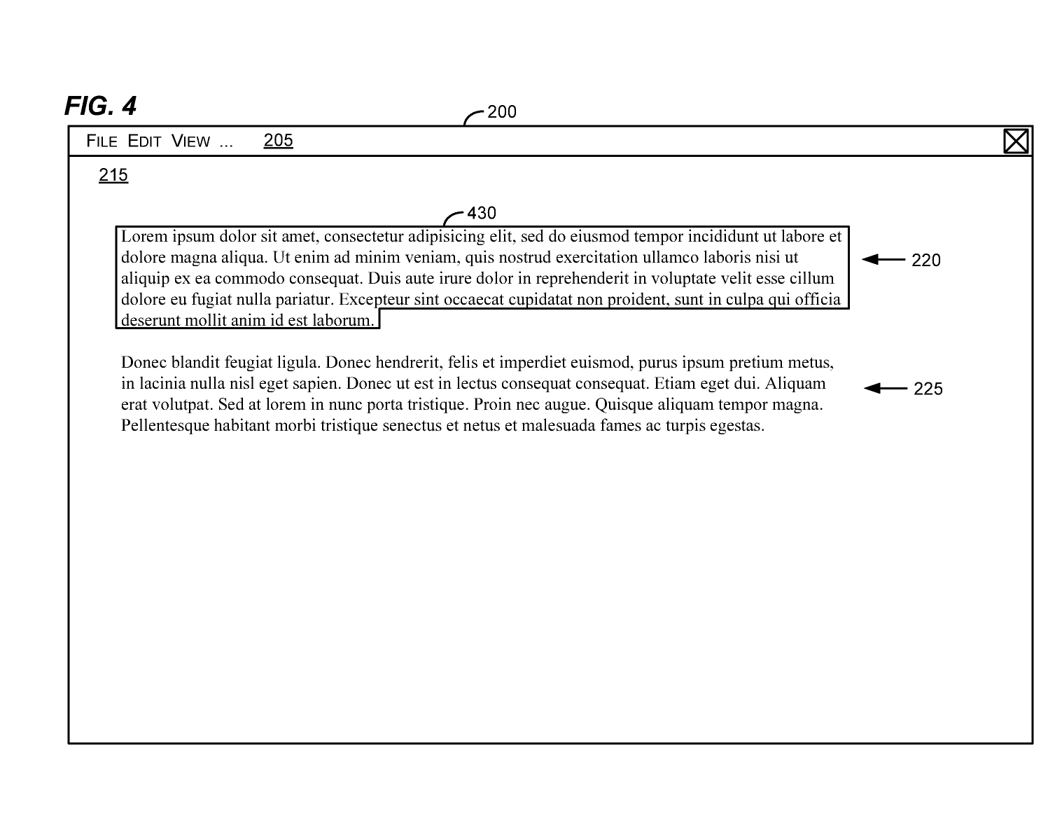

At block 530, the selection is snapped to the paragraph. For example, referring to FIGS. 2 and 4, the processing unit 120 may update a data structure in RAM 132 to indicate that the selection 230 now covers the entire paragraph 220 (as illustrated by selection 430 in FIG. 4).

At block 535, snapping of the paragraph is indicated on an output device. For example, referring to FIG. 4, a line may be drawn that surrounds the paragraph 220 and visually indicates that the selection 430 has been snapped to the paragraph.

The visual indication illustrated in FIG. 4 is exemplary only. Other types of indications may include, for example, highlighted text, different colored text, inverted text, markers around the selected paragraph, other graphical indications, other non-graphical indications (e.g., voice or other sound, braille, or the like), and the like.

At block 540, other actions, if any, may be performed.

In addition, additional actions may be performed at block 525 as part of determining whether paragraph snapping conditions are met. These additional actions may include, for example:

1. Detecting whether the expansion input is provided via a touch screen, and, if not, disabling paragraph snapping behavior.

2. Detecting that the selection as resized expands into white space (e.g., the blank space between paragraphs), and visually indicating that the selection includes the entire paragraph but does not include the white space.

3. Determining that selection input is expansion input if the selection input is in a direction of flow of the text.

Turning to FIG. 6, at block 605, the actions begin. At block 610, contraction input is received. Contraction input includes input that makes the selection size smaller. For example, referring to FIG. 4, a user may provide expansion input by placing a finger on the end of the selection 430 and dragging the finger left or up in the paragraph 220. Furthermore, contraction input may be received for any size selection and is not restricted to selections of full paragraphs.

At block 615, paragraph snapping is cancelled. For example, referring to FIG. 1, the processing unit 120 may update a data structure in the RAM 132 that indicates that paragraph snapping is disabled for a selection activity.

At block 620, the selection is made smaller in accordance with the contraction input. For example, referring to FIGS. 3 and 4, if the selection 430 resulted from paragraph snapping as the selection 330 was expanded, then when paragraph snapping is cancelled for the paragraph 220, the start of the selection may return to the beginning of the selection 330 of FIG. 3.

In addition, after paragraph snapping is cancelled, paragraph snapping rules may be disabled. Once disabled, a user may select specific parts of a paragraph by providing expanding or contracting input for the selection.

At block 625, other actions, if any, may be performed. For example, if additional user input indicates that the selection is to be expanded to a second paragraph, paragraph snapping behavior may be re-enabled.

The processing unit 120 of FIG. 1 may be programmed through computer-executable instructions to perform the actions indicated above. The monitor 191, printer 196, speakers 197, or other output device may be used to provide a representation of a document on which paragraph snapping is performed.

As can be seen from the foregoing detailed description, aspects have been described related to paragraph snapping. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving an indication of a selection of text of a paragraph;
receiving expansion input with respect to the selection;
resizing the selection in accordance with the expansion input; and
if the selection as resized is less than all of the text of the paragraph but satisfies a set of one or more paragraph snapping conditions, performing a paragraph snapping action, the paragraph snapping action including indicating, via an output device, that the selection as resized includes the entire paragraph.

2. The method of claim 1, wherein the set of one or more paragraph snapping conditions includes a condition that the selection as resized starts at the beginning of the paragraph and includes an amount of text of the paragraph that is over a threshold.

3. The method of claim 1, wherein the set of one or more paragraph snapping conditions includes a condition that the selection as resized includes at least N lines of text of the paragraph and the paragraph includes 2N lines of text.

4. The method of claim 1, wherein the set of one or more paragraph snapping conditions includes a condition that the selection as resized is greater than a pre-defined percentage of the paragraph.

5. The method of claim 4, further comprising receiving percentage input and defining the pre-defined percentage based on the percentage input.

6. The method of claim 5, where receiving the percentage input comprises receiving input that indicates one of three types of paragraph snapping behavior, namely: aggressive, non-aggressive, and no snapping.

7. The method of claim 1, further comprising detecting whether the expansion input is provided via a touch screen, and, if not, disabling paragraph snapping behavior for the selection.

8. The method of claim 1, further comprising, if the selection as resized is expanded into a second paragraph, visually indicating that the selection includes the entire second paragraph.

9. The method of claim 1, further comprising, if the selection as resized expands into white space after the paragraph, visually indicating that the selection includes the entire paragraph but does not include the white space.

10. The method of claim 1, further comprising determining that selection input is the expansion input if the selection input is in a direction of flow of the text.

11. The method of claim 1, further comprising receiving contraction input and in response thereto, cancelling paragraph snapping behavior for the paragraph.

12. The method of claim 11, further comprising visually indicating that the selection starts with text that the selection started with prior to the paragraph snapping action.

13. The method of claim 11, further comprising shrinking the selection to end at a location indicated by the contraction input.

14. The method of claim 12, further comprising re-enabling snapping behavior in response to additional input that indicates that the selection is to be expanded to a second paragraph.

15. In a computing environment, a system, comprising:
a memory structured to store data of a document;
an output device structured to provide a representation of the document;
a processor coupled to the memory and the output device, the processor programmed to perform actions, the actions comprising:
receiving an indication of a selection of text of a paragraph of the document;
receiving expansion input with respect to the selection; and
if the expansion input indicates that the selection is to be expanded to less than all of the text of the paragraph but a set of one or more paragraph snapping conditions is satisfied, performing a paragraph snapping action, the paragraph snapping action including providing output data to the output device to indicate that the selection includes the entire paragraph.

16. The system of claim 15, wherein the processor is further programmed to perform additional actions, the additional actions comprising detecting whether the output device is structured to sense touch input and if not, disabling paragraph snapping behavior for the selection.

17. The system of claim 15, wherein the processor is further programmed to perform additional actions, the additional actions comprising refraining from visually indicating that white space that is after or before the paragraph is part of the selection.

18. The system of claim 15, wherein the processor is further programmed to perform additional actions, the additional actions comprising receiving contraction input and in response thereto, cancelling snapping behavior for the paragraph.

19. The system of claim 18, wherein the processor being programmed to cancel snapping behavior for the paragraph, comprises the processor being programmed to provide output data to a display to visually indicate that the selection starts with text that the selection started with prior to the paragraph snapping action.

20. A computer storage medium having computer-executable instructions, which when executed perform actions, comprising:
on a touch sensitive device, receiving an indication of selection of text of a paragraph;
receiving touch input with respect to the selection, the touch input comprising touch input in a direction of text flow of the paragraph; and
if resizing the selection in response to the touch input causes the selection to be greater than a pre-defined percentage of the paragraph, then visually indicating via an output device of the touch sensitive device that the selection includes the entire paragraph.
